(19) United States
(12) Patent Application Publication
(10) Pub. No.: US 2011/0207413 A1
(43) Pub. Date: Aug. 25, 2011

(54) MOBILE DEVICE AND METHOD FOR REGULATING ANTENNA CHARACTERISTIC THEREOF

(75) Inventors: CHIA-HUNG SU, Tu-Cheng (TW); CHO-KANG HSU, Tu-Cheng (TW)

(73) Assignee: CHI MEI COMMUNICATION SYSTEMS, INC., Tu-Cheng City (TW)

(21) Appl. No.: 12/848,217

(22) Filed: Aug. 1, 2010

(30) Foreign Application Priority Data
Feb. 23, 2010 (TW) 99105124

(51) Int. Cl. H04B 17/00; H01Q 1/50

(52) U.S. Cl. 455/67.11; 343/876

(57) ABSTRACT

A mobile device includes an antenna module, a calculation module, a location sensor, a determination module, and a regulator module. The calculation module calculates a received signal strength indication (RSSI) of the antenna module. The location sensor senses a user relative to the mobile device when the mobile device is in a communication mode. The determination module determines whether the RSSI degrades over a default period and whether the user is near the mobile device when the mobile device is in the communication mode. The regulator module regulates antenna characteristic of the mobile device when the RSSI degrades over the default period and the user is near the mobile device when the mobile device is in the communication mode.

### BACKGROUND

1. Technical Field

The present disclosure relates to a mobile device and method for regulating antenna characteristic of the mobile device.

2. Description of Related Art

During operation, many mobile devices are held very close to a user's body, for example next to a user's ear. RF signals transmitted from the mobile devices are sometimes impaired due to the close proximity of a person's hand/body to antennas of the mobile devices.

### BRIEF DESCRIPTION OF THE DRAWINGS

FIG. 1 is a block diagram of one embodiment of a mobile device.

FIG. 2 is a block diagram of first embodiment of a regulator module of FIG. 1.

FIG. 3 is a block diagram of second embodiment of a regulator module of FIG. 1.

FIG. 4 is a flowchart illustrating one embodiment of a method for regulating an antenna characteristic of a mobile device.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

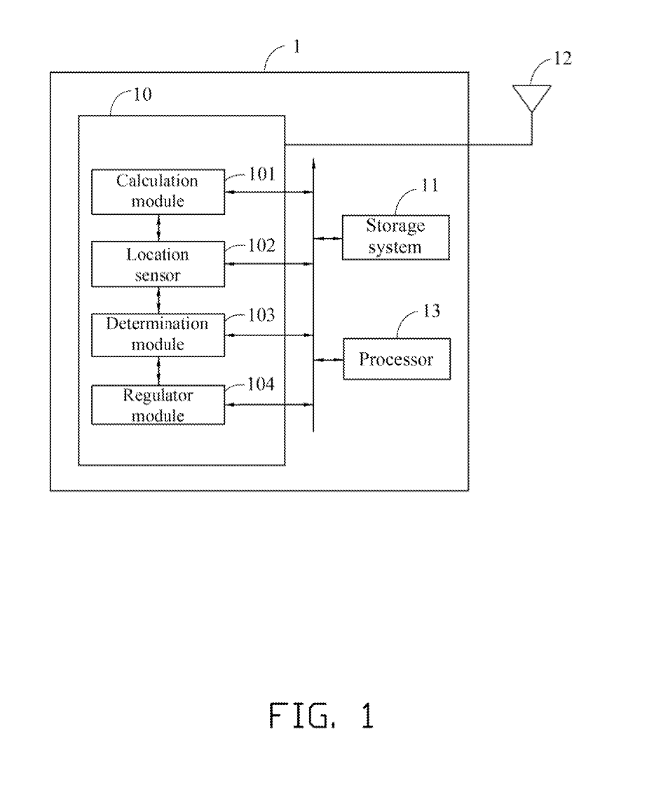

FIG. 1 is a block diagram of one embodiment of a mobile device 1. The mobile device 1 includes a system 10, a storage system 11, an antenna module 12, and a processor 13. The system 10 includes a calculation module 101, a location sensor 102, a determination module 103, and a regulator module 104. The processor 13 may execute one or more programs stored in the storage system 11 to provide functions for the calculation module 101, the location module 102, the determination module 103, and the regulator module 104.

The mobile device 1 is generally controlled and coordinated by an operating system, such as UNIX, Linux, Windows, Mac OS, an embedded operating system, or any other compatible system. Alternatively, the system 10 may be controlled by a proprietary operating system. Typical operating systems control and schedule computer processes for execution, perform memory management, provide file system, networking, and I/O services, and provide a user interface, such as a graphical user interface (GUI), among other tasks.

The antenna module 12 is operable to transmit and receive wireless signals. The antenna module 12 may work with high frequency bands or low frequency bands. In the embodiment, high frequency bands include GSM 1800, GSM 1900, WCDMA 1900, and WCDMA 2100. Low frequency bands include GSM 850, GSM 900, and WCDMA 850. The detecting module 101 is operable to continually determine received signal strength indication (RSSI) of the antenna module 12.

The location sensor 102 is operable to sense a user relative to the mobile device 1. The location sensor 102 may be a proximity sensor, a passive infrared (PIR) sensor, or a microwave detector, for example. The location sensor 102 can be used to sense the user when the mobile device 1 is in a communication mode (e.g., when receiving a phone call).

The determination module 103 is operable to determine whether the RSSI degrades over a default period and whether the user is near the mobile device 1 when the mobile device 1 is in the communication mode. In the embodiment, the default period is two seconds. The antenna characteristic is in a first status when the mobile device 1 is on standby. The regulator module 104 is operable to regulate the antenna characteristic to a second status when the mobile device 1 is in the communication mode.

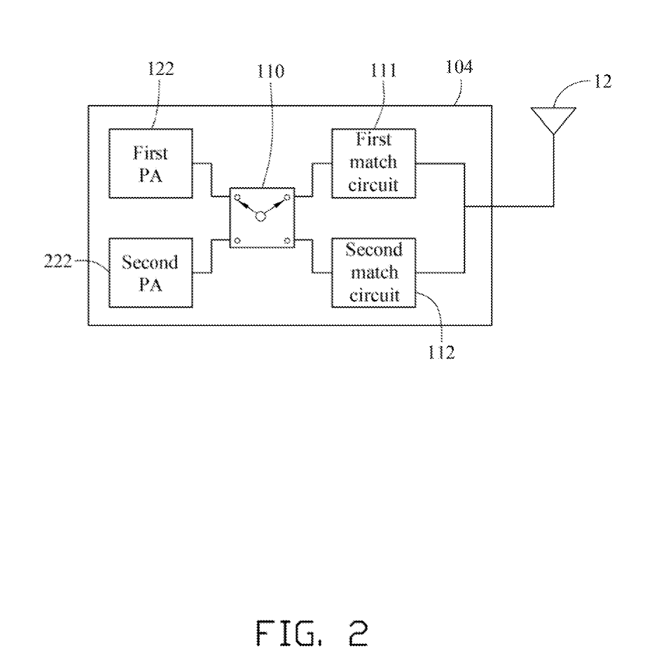

FIG. 2 is a block diagram of first embodiment of the regulator module 104. The regulator module 104 includes a first match circuit 111, a second match circuit 112, a switch circuit 110, a first power amplifier (PA) 122, and a second power amplifier (PA) 222. In the first status, the switch circuit 110 connects the antenna module 12 with the first match circuit 111 and the first power amplifier 122. In the embodiment, output power of the second amplifier 222 is greater than that of the first amplifier 122. The so-called “match circuit” is operable to regulate a plurality of antenna parameters. The antenna parameters may include reflective coefficient, antenna gain, and voltage standing wave ratio (VSWR).

If the antenna module 12 works with the low frequency band and a degradation of RSSI exceeds 5 dB for two seconds when the user is near the mobile device 1, the regulator module 104 regulates the antenna characteristic to the second status. In the embodiment, the second status may be that the switch circuit 110 connects the antenna module 12 with the second match circuit 112 and the first power amplifier 122.

If the antenna module 12 works with the high frequency band and the degradation of RSSI exceeds 3 dB for two seconds when the user is near the mobile device 1, the regulator module 104 regulates the antenna characteristic to the second status. In the embodiment, the second status may be that the switch circuit 110 connects the antenna module 12 with the second match circuit 112 and the first power amplifier 122.

If the antenna module 12 works with the low frequency band and the degradation of RSSI exceeds 5 dB for two seconds when the user is near the mobile device 1, the regulator module 104 regulates the antenna characteristic to the second status. In the embodiment, the second status may be that the switch circuit 110 connects the antenna module 12 with the first match circuit 111 and the second power amplifier 222.

If the antenna module 12 works with the low frequency band and the degradation of RSSI exceeds 5 dB for two seconds when the user is near the mobile device 1, the regulator module 104 regulates the antenna characteristic to the second status. In the embodiment, the second status may be that the switch circuit 110 connects the antenna module 12 with the first match circuit 111 and the second power amplifier 222.

If the antenna module 12 works with the high frequency band and the degradation of RSSI exceeds 3 dB for two seconds when the user is near the mobile device 1, the regulator module 104 regulates the antenna characteristic to the second status. In the embodiment, the second status may be that the switch circuit 110 connects the antenna module 12 with the first match circuit 111 and the second power amplifier 222.

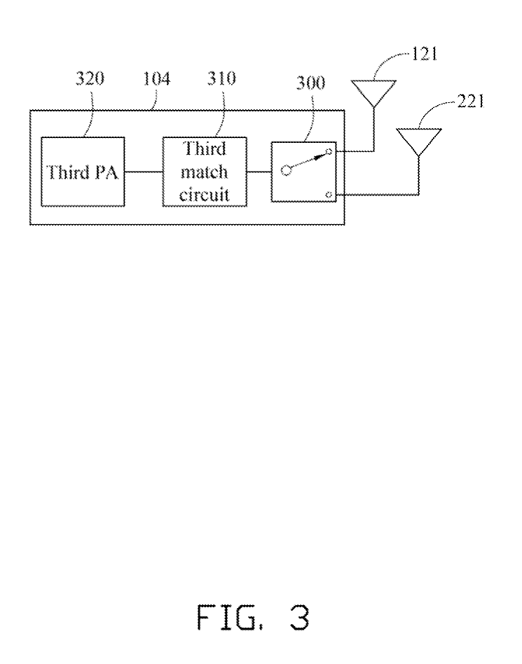

FIG. 3 is a block diagram of second embodiment of the regulator module 104. The antenna module 12 further includes a first antenna 121 and a second antenna 221. The regulator module 104 includes a switch circuit 300, a third match circuit 310, and a third power amplifier 320. In the first status, the switch circuit 300 connects the first antenna 121 with the third match circuit 310 and a third power amplifier 320.

If the antenna module 12 works with the low frequency band and the degradation of RSSI exceeds 5 dB over two seconds when the user is near the mobile device 1, the regulator module 104 regulates the antenna characteristic to the second status. In the embodiment, the second status may be that the switch circuit 110 connects the second antenna 221 with the third match circuit 310 and a third power amplifier 320.

If the antenna module 12 works with the high frequency band and the degradation of RSSI exceeds 3 dB for two seconds when the user is near the mobile device 1, the regulator module 104 regulates the antenna characteristic to the second status. In the embodiment, the second status may be that the switch circuit 110 connects the second antenna 221 with the third match circuit 310 and a third power amplifier 320.

The mobile device 1 may further includes a first feed point, a second feed point, a first ground point, and a second ground point (the feed point and the ground point are not shown). In the first status, the switch circuit 110 connects the antenna module 12 with the first feed point and the first ground point. The second status may include that the regulator module 104 connects the antenna module 12 with the first feed point and the second ground point, the regulator module 104 connects the antenna module 12 with the second feed point and the first ground point, or the regulator module 104 connects the antenna module 12 with the second feed point and the second ground point.

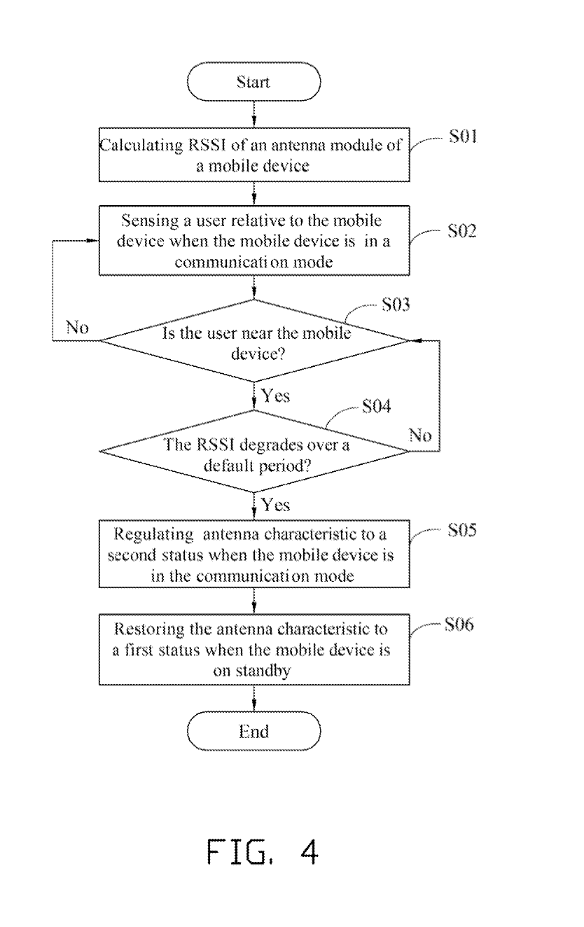

FIG. 4 is a flowchart of an alarm method for the electronic device 1. Depending on the embodiment, additional blocks in the flow of FIG. 4 may be added, others removed, and the ordering of the blocks may be changed.

In block S01, the calculation module 101 continually detects the RSSI of the antenna module 12.

In block S02, the location sensor 102 senses the user relative to the mobile device 1 when the mobile device 1 is in the communication mode.

In block S03, the determination module 103 determines whether the user is near the mobile device 1 when the mobile device 1 is in the communication mode. If the user is not near the mobile device 1, the process goes to block S02. If the user is near the mobile device 1, the process goes to block S04.

In block S04, the determination module 103 determines whether the RSSI degrades over a default period when the mobile device 1 is in the communication mode. If the RSSI does not degrade over a default period, the process goes to block S03.

If the RSSI degrades over a default period, in block S05, the regulator module 104 regulates the antenna characteristic to the second status.

In block S06, the regulator module 104 restores the antenna characteristic to the first status when the mobile device 1 is on standby.

The present disclosure provides a mobile device which may regulate antenna characteristic thereof. Antenna performance of the mobile device is improved when the mobile device is in a communication mode.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for regulating antenna characteristic of a mobile device, the antenna characteristic being in a first status when the mobile device is on standby, the mobile device comprising an antenna module and a regulator module, the method comprising:
calculating a received signal strength indication (RSSI) of the antenna module;
sensing a user relative to the mobile device when the mobile device is in a communication mode;
determining whether the user is near the mobile device when the mobile device is in the communication mode;
determining whether the RSSI degrades over a default period when the mobile device is in the communication mode; and
regulating the antenna characteristic to a second status if the received signal degrades over a default period when the mobile device is in the communication mode.

2. The method of claim 1, wherein the regulator module comprises a first match circuit and a second match circuit, wherein the step of regulating the antenna characteristic further comprises:
connecting the antenna module with the second match circuit rather than the first match circuit.

3. The method of claim 1, wherein the regulator module comprises a power amplifier and a power amplifier, wherein the step of regulating the antenna characteristic further comprises:
connecting the antenna module with the second power amplifier rather than the first power amplifier.

4. The method of claim 1, wherein the mobile device further comprises a first feed point and a second feed point, wherein the step of regulating the antenna characteristic further comprises:
connecting the antenna module with the second feed point rather than the first feed point.

5. The method of claim 1, wherein the mobile device further comprises a first ground point and a second ground point, wherein the step of regulating the antenna characteristic further comprises:
connecting the antenna module with the second ground point rather than the first ground point.

6. The method of claim 1, wherein the antenna module further comprises a first antenna and a second antenna, wherein the step of regulating the antenna characteristic further comprises:
connecting with the second antenna rather than the first antenna.

7. A mobile device, comprising:
a storage system;
at least one processor;
one or more programs stored in the storage system and being executable by the at least one processor;
an antenna module operable to transmit and receive wireless signals;
a calculation module operable to calculate a received signal strength indication (RSSI) of the antenna module;
a location sensor operable to sense a user relative to the mobile device;
a determination module operable to determine whether the RSSI degrades over a default period and whether the user is near the mobile device when the mobile device is in a communication mode; and
a regulator module operable to regulate antenna characteristic of the mobile device when the RSSI degrades over the default period and the user is near the mobile device when the mobile device is in the communication mode.

8. The mobile device of claim 7, wherein the regulator module further comprises a first match circuit and a second match circuit.

9. The mobile device of claim 7, wherein the regulator module further comprises a first power amplifier and a second power amplifier.

10. The mobile device of claim 7, wherein the mobile device further comprises a first feed point and a second feed point.

11. The mobile device of claim 7, wherein the mobile device further comprises a first ground point and a second ground point.

12. The mobile device of claim 7, wherein the antenna module further comprises a first antenna and a second antenna.

13. A storage medium having stored thereon instructions that, when executed by a processor, causing the processor to perform a method for regulating antenna characteristic of a mobile device, the antenna characteristic is in a first status when the mobile device is on standby, the mobile device comprises an antenna module and a regulator module, wherein the method comprises:
calculate a received signal strength indication (RSSI) of the antenna module;
sense a user relative to the mobile device when the mobile device is in a communication mode;
determine whether the user is near the mobile device when the mobile device is in the communication mode;
determine whether the RSSI degrades over a default period when the mobile device is in the communication mode; and
regulate the antenna characteristic to a second status if the received signal degrades over a default period when the mobile device is in the communication mode.

14. The storage medium of claim 13, wherein the regulator module comprises a first match circuit and a second match circuit, wherein the step of regulating the antenna characteristic further comprises:
connect the antenna module with the second match circuit rather than the first match circuit.

15. The storage medium of claim 13, wherein the regulator module comprises a power amplifier and a power amplifier, wherein the step of regulating the antenna characteristic further comprises:
connect the antenna module with the second power amplifier rather than the first power amplifier.

16. The storage medium of claim 13, wherein the mobile device further comprises a first feed point and a second feed point, wherein the step of regulating the antenna characteristic further comprises:
connect the antenna module with the second feed point rather than the first feed point.

17. The storage medium of claim 13, wherein the mobile device further comprises a first ground point and a second ground point, wherein the step of regulating the antenna characteristic further comprises:
connect the antenna module with the second ground point rather than the first ground point.

18. The storage medium of claim 13, wherein the antenna module further comprises a first antenna and a second antenna, wherein the step of regulate the antenna characteristic further comprises:
connect with the second antenna rather than the first antenna.
